(19) United States
(12) Patent Application Publication
(10) Pub. No.: US 2017/0261093 A1
(43) Pub. Date: Sep. 14, 2017

(54) LUBRICATION STRUCTURE OF POWER TRANSMISSION APPARATUS

(71) Applicants: TOYOTA JIDOSHA KABUSHIKI KAISHA, Toyota-shi (JP); AISIN AW CO., LTD., Anjo-shi (JP)

(72) Inventors: Kozo YAMAMOTO, Nagoya-shi (JP); Hideki NAKAGAWA, Toyota-shi (JP); Hirofumi NAKADA, Toyota-shi (JP); Yosuke ANAN, Toyota-shi (JP); Haruki SHIRASAKA, Anjo-shi (JP)

(73) Assignees: TOYOTA JIDOSHA KABUSHIKI KAISHA, Toyota-shi (JP); AISIN AW CO., LTD., Anjo-shi (JP)

(21) Appl. No.: 15/452,158

(22) Filed: Mar. 7, 2017

(30) Foreign Application Priority Data
Mar. 11, 2016 (JP) 2016-047769

(51) Int. Cl. F16H 57/04

(52) U.S. Cl. CPC F16H 57/0424

(57) ABSTRACT

A lubrication structure of a power transmission apparatus including a case member is provided. The lubrication structure includes a first oil passage, a second oil passage, and an oil passage pipe. The first oil passage is provided in the case member, and includes a first opening that opens at a wall surface of the case member. The second oil passage is provided in the case member, and includes a second opening that opens at the wall surface of the case member. The oil passage pipe is attached to the wall surface, and includes an end portion inserted into the second opening to be connected to the second oil passage. The oil passage pipe includes a through-hole that opens at an outer peripheral surface of the oil passage pipe. The through-hole is provided adjacent to the first opening such that oil is supplied from the through-hole into the first oil passage.

### INCORPORATION BY REFERENCE

The disclosure of Japanese Patent Application No. 2016-047769 filed on Mar. 11, 2016 including the specification, drawings and abstract is incorporated herein by reference in its entirety.

### BACKGROUND

1. Technical Field

The present disclosure relates generally to a lubrication structure of a power transmission apparatus mounted in, for example, a vehicle, and relates more specifically to a lubrication structure in which an oil pipe (oil passage pipe) attached to a case member of, for example, a transmission is connected to oil passages in the case member.

2. Description of Related Art

In a conventionally-used automatic transmission of a vehicle, a plurality of oil passages is provided in a case member, and oil supplied from, for example, an oil pump is supplied through the oil passages to portions that need to be lubricated or cooled. In some cases, an oil passage extending over a sufficiently long section cannot be provided in a wall of a case member. In such a case, an end portion of the oil passage opens at a wall surface so as to be used as a pipe insertion hole, and an end portion of an oil pipe is inserted into the pipe insertion hole to be connected to the oil passage.

Specifically, for example, FIG. 10 of Japanese Patent Application Publication No. 2014-119049 (JP 2014-119049 A) illustrates a structure in which an insertion portion at a distal end of an oil pipe is inserted into a pipe insertion hole of an oil passage defining block to be connected to an oil passage. In an example illustrated in the drawing, the oil pipe is bent such that the insertion portion of the oil pipe extends obliquely, and a lower portion (bent portion) of a bracket brazed to a portion of the oil pipe in the vicinity of the insertion portion is seated on a support boss and fastened with a bolt.

### SUMMARY

In some cases, oil is required to be supplied to two or more oil passages, instead of being supplied to only one oil passage, by an oil pipe attached to a case member as described above. In such a case, as illustrated in an example in FIG. 3, a branch pipe is connected to an intermediate portion of the oil pipe to allow the flow of the oil to branch off. In order to achieve this configuration, it is necessary to provide a through-hole in the intermediate portion of the oil pipe, and to join an end portion of the branch pipe to the oil pipe through, for example, brazing.

When the end portion of the branch pipe is brazed to the intermediate portion of the oil pipe, the branch pipe needs to be provided as an additional component and the component cost is increased accordingly. Further, a process of brazing the end portion of the branch pipe to the oil pipe is required. As a result, a cost increase is inevitable.

The present disclosure curbs cost increases by introducing refinements into a structure for connecting an oil pipe (oil passage pipe) to oil passages in a case member.

An aspect of the present disclosure relates to a lubrication structure of a power transmission apparatus including a case. The lubrication structure includes a first oil passage, a second oil passage, and an oil passage pipe. The first oil passage is provided in the case, and includes a first opening that opens at a wall surface of the case. The second oil passage is provided in the case, and includes a second opening that opens at the wall surface of the case. The oil passage pipe is attached to the wall surface of the case, and includes an end portion inserted into the second opening to be connected to the second oil passage. The oil passage pipe includes a through-hole that opens at an outer peripheral surface of the oil passage pipe. The through-hole is provided adjacent to the first opening such that oil is supplied from the through-hole into the first oil passage.

In the lubrication structure according to the above aspect, the through-hole is provided in the oil passage pipe (hereinafter, referred to as “oil pipe”) for supplying the oil to each portion (portion that needs to be lubricated or cooled) of the power transmission apparatus, and the through-hole is provided adjacent to the opening of the first oil passage that opens at the wall surface of the case member. With this configuration, a portion of the oil supplied from, for example, an oil pump and flowing through the oil pipe flows from the through-hole into the first oil passage via the first opening.

The end portion of the oil pipe is inserted into the second opening of the second oil passage provided in the case member. With this configuration, a portion of the oil flowing through the oil pipe flows from the end portion of the oil pipe into the second oil passage. Thus, it is possible to supply the oil to the first and second oil passages without the need to attach a branch pipe to the oil pipe, for example, through brazing. Therefore, a component cost for a branch pipe and man-hours for brazing a branch pipe are no longer required. As a result, it is possible to curb cost increases.

In the lubrication structure according to the above aspect, the cross-sectional area of the through-hole of the oil pipe may be smaller than the cross-sectional area of the first opening. According to this aspect, the oil appropriately flows from the through-hole of the oil pipe into the first opening. The through-hole may be provided in the vicinity of a bent portion of the oil pipe. According to this aspect, positioning of the through-hole with respect to the case member is performed using the bent portion, whereby the through-hole is provided adjacent to the first opening.

In the lubrication structure according to the above aspect, the through-hole of the oil pipe is provided adjacent to the first opening of the wall surface of the case member, whereby the oil is supplied to the first oil passage. In addition, the end portion of the oil pipe is inserted into the second opening of the second oil passage of the case member, whereby the oil is supplied to the second passage. Thus, it is no longer necessary to attach a branch pipe to the oil pipe, for example, through brazing. As a result, it is possible to curb increases in a component cost and the number of man-hours, thereby curbing cost increases.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is an exploded perspective view of a transmission case according to an embodiment of the present disclosure, FIG. 1 schematically illustrating a plurality of case members of the transmission case;

FIG. 2 is a sectional view taken along line II-II in FIG. 2, FIG. 2 illustrating a structure for connecting a first oil passage and an oil pipe to each other; and

FIG. 3 is a sectional view illustrating an example of a structure in related art provided on the assumption that a branch pipe is brazed to an oil pipe.

### DETAILED DESCRIPTION OF EMBODIMENTS

Hereinafter, an embodiment of the present disclosure will be described with reference to the accompanying drawings. The present embodiment describes an example case where the present disclosure is applied to a continuously variable transmission that is a power transmission apparatus of an automobile. However, the apparatus to which the present disclosure is applied should not be limited to a continuously variable transmission, and the present disclosure may be applied to various power transmission apparatuses, such as a transaxle of a hybrid vehicle and a stepped automatic transmission.

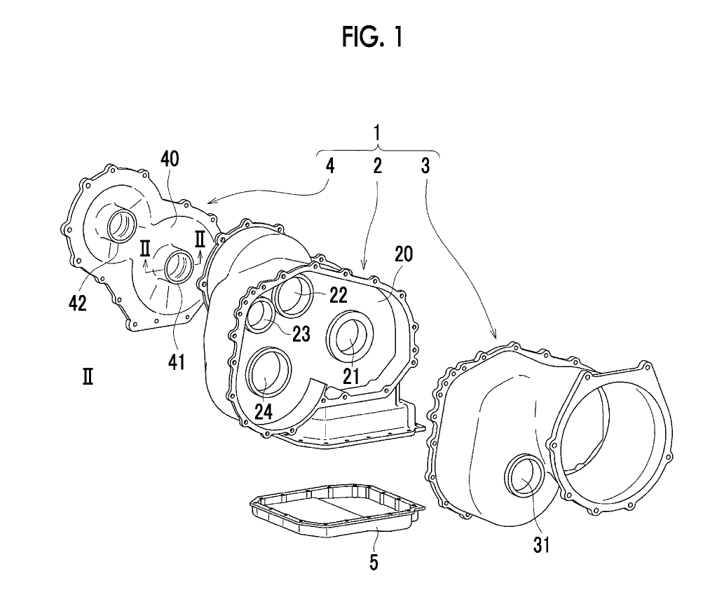

As schematically illustrated in FIG. 1, a continuously variable transmission according to the present embodiment includes a transmission case 1 having, for example, a three-piece structure. Specifically, the continuously variable transmission includes case members, such as a center case 2 disposed at the center, a side case 3, and a cover member 4. The side case 3 is attached to one side (right front side in FIG. 1) of the center case 2, and the cover member 4 is attached to the other side (left rear side in FIG. 1) of the center case 2. A bottom portion of the center case 2 opens downward, and an oil pan 5 is attached to the bottom portion of the center case 2.

A torque converter (not illustrated), a forward-rearward switching mechanism (not illustrated), a differential (not illustrated), and so forth are accommodated between the center case 2 and the side case 3. A belt-type continuously variable transmission mechanism (not illustrated) is accommodated between the center case 2 and the cover member 4. Because the continuously variable transmission mechanism is a known mechanism in which a transmission belt made of metal is looped over a primary pulley and a secondary pulley, the description thereof will be omitted.

As illustrated in FIG. 1, four shaft insertion holes 21, 22, 23 24 are provided in a partition wall 20 of the center case 2, and a shaft insertion hole 31 is provided in the side case 3. The cover member 4 is provided with two bosses 41, 42 protruding from an inner surface of a wall 40 of the cover member 4. End portions of shafts of the continuously variable transmission mechanism, the differential, and so forth are inserted through the shaft insertion holes 21, 22, 23, 24, 31 and the bosses 41, 42, and the shafts are rotatably supported via, for example, bearings.

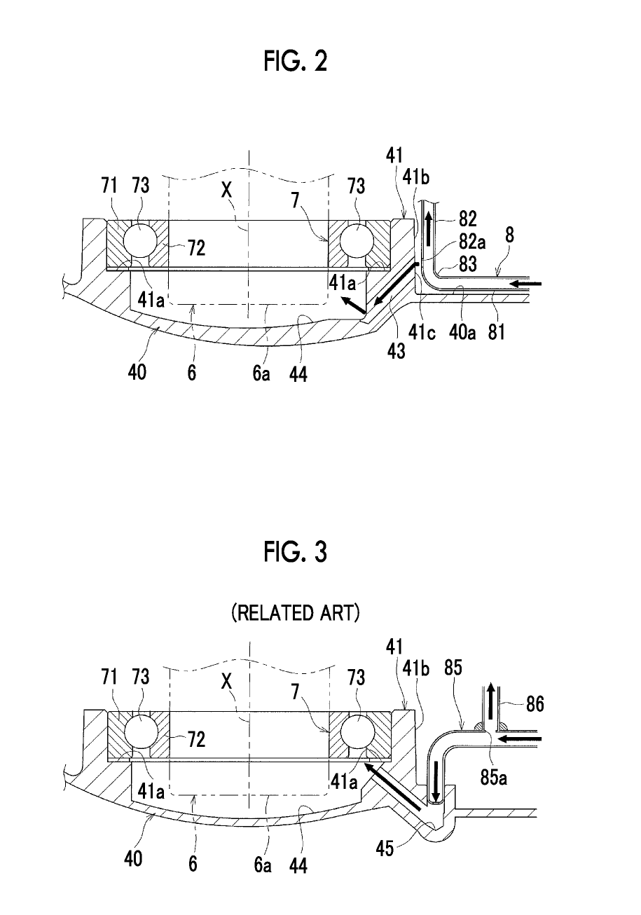

FIG. 2 is an enlarged sectional view of the boss 41 and its surroundings. As illustrated in FIG. 2, the wall 40 of the cover member 4 has a shallow plate-shaped portion that faces an end portion 6a of a shaft 6 of the primary pulley (hereinafter, referred to as “pulley shaft 6”) indicated by an imaginary line. The shallow plate-shaped portion of the wall 40 gradually bulges outward (downward in FIG. 1) with respect to the cover member 4. The boss 41 protrudes from the shallow plate-shaped portion inward with respect to the cover member 4 so as to surround the end portion 6a of the pulley shaft 6.

As illustrated in FIG. 2, the boss 41 has a cylindrical shape. In the boss 41, the thickness of a base-side portion (lower-side portion in FIG. 2) that is continuous with the wall 40 of the cover member 4 is relatively large, and the thickness of an opening-side portion (upper-side portion in FIG. 2) on the opposite side of the boss 41 from the base-side portion is relatively small. In an example illustrated in FIG. 2, the thickness of the opening-side portion is about half the thickness of the base-side portion, and a step 41a is provided between the opening-side portion and the base-side portion. An outer ring 71 of a ball bearing 7 is press-fitted to the opening-side portion of the boss 41, which extends to the step 41a.

Specifically, in the ball bearing 7, a plurality of balls 73 is disposed between the outer ring 71 and an inner ring 72 that are assembled together so as to be rotatable relative to each other. The balls 73 are disposed at substantially equal intervals in the circumferential direction of the ball bearing 7. Further, the end portion 6a of the pulley shaft 6 is provided on the inner periphery of the inner ring 72 so as to be inserted through the ball bearing 7. Thus, the end portion 6a of the pulley shaft 6 is rotatably supported by the boss 41 of the cover member 4 via the ball bearing 7. A roller bearing or like may be used instead of the ball bearing 7.

Structure of Oil Passage

A first oil passage 43 through which oil is supplied to the ball bearing 7 or the like is provided in the boss 41, and the oil is supplied from an oil pipe 8 (oil passage pipe) attached to an outer peripheral surface 41b of the boss 41 (wall surface of the case member). That is, the first oil passage 43 extends through the base-side portion of the boss 41 in the radial direction, and the first oil passage 43 extends to be slanted such that an inner peripheral-side portion of the first oil passage 43 is closer, in the radial direction of the boss 41, to the axis X of the boss 41 than an outer peripheral-side portion of the first oil passage 43 is.

An inner peripheral end 43a of the first oil passage 43 opens at a position that is close to the bottom portion of an oil chamber 44 defined in the boss 41, whereas an outer peripheral end of the first oil passage 43 opens at the outer peripheral surface 41b of the boss 41. An opening 41c of the first oil passage 43 is provided adjacent to a through-hole 82a provided in the oil pipe 8. With this configuration, as schematically indicated by arrows in FIG. 2, a part of the oil flowing through the oil pipe 8 flows into the first oil passage 43 from the through-hole 82a.

Specifically, the oil pipe 8 has a generally L-shape, and includes an upstream-side straight pipe portion 81, a downstream-side straight pipe portion 82, and a bent pipe portion 83. The upstream-side straight pipe portion 81 is located upstream of a portion bent about 90° in the oil flow direction. The downstream-side straight pipe portion 82 is located downstream of the portion bent about 90° in the oil flow direction. The bent pipe portion 83 connects the upstream-side straight pipe portion 81 and the downstream-side straight pipe portion 82 to each other. As illustrated in FIG. 2, when the upstream-side straight pipe portion 81 is brought into contact with a flange surface 40a of the wall 40 of the cover member 4, the downstream-side straight pipe portion 82 extends upward in FIG. 2 along the outer peripheral surface 41b of the boss 41.

The through-hole 82a is provided in the downstream-side straight pipe portion 82 of the oil pipe 8 extending along the outer peripheral surface 41b of the boss 41, such that the through-hole 82a opens toward the outer peripheral surface 41b. The through-hole 82a is provided adjacent to the opening 41c of the first oil passage 43 that opens at the outer peripheral surface 41b of the boss 41. That is, when the upstream-side straight pipe portion 81 of the oil pipe 8 bent in an L-shape is brought into contact with the flange surface 40a of the wall 40 of the cover member 4 using the upstream-side straight pipe portion 81 as a reference, positioning of the through-hole 82a provided in the downstream-side straight pipe portion 82 with respect to the opening 41c is performed.

The upstream-side straight pipe portion 81 is secured to the wall 40 of the cover member 4 via, for example, a bracket (not illustrated). Although there seems to be a gap between the upstream-side straight pipe portion 81 of the oil pipe 8 and the flange surface 40a of the wall 40 in FIG. 2, actually, the upstream-side straight pipe portion 81 is in contact with the flange surface 40a. Thus, positioning of the through-hole 82a is performed at a sufficiently high degree of accuracy.

On the other hand, as illustrated in FIG. 2, there is a gap between the downstream-side straight pipe portion 82 of the oil pipe 8 and the outer peripheral surface 41b of the boss 41 (the gap in FIG. 2 is exaggerated for the purpose of illustration, and the actual gap is small). Due to, for example, variations in the inclination of the outer peripheral surface 41b of the boss 41, which is formed through casting, and variations in the dimensions of the oil pipe 8, the through-hole 82a of the oil pipe 8 and the opening 41c of the first oil passage 43 are provided adjacent to each other with the gap left therebetween.

Despite the presence of the gap, the oil appropriately flows into the opening 41c of the first oil passage 43 from the through-hole 82a of the oil pipe 8. That is, in the present embodiment, the cross-sectional area of the through-hole 82a is smaller than the cross-sectional area of the opening 41c, and thus the through-hole 82a functions as an ejection hole (orifice). Thus, the oil gushes out of the oil pipe 8 through the through-hole 82a, and the oil flows into the first oil passage 43 from the opening 41c.

The size (cross-sectional area) of the through-hole 82a is tuned up such that a required amount of oil is supplied to the first oil passage 43 while the pressure of the oil flowing through the oil pipe 8 is appropriately maintained. The size (cross-sectional area) of the through-hole 82a is set to be smaller than at least the size (cross-sectional area) of the oil passage in the oil pipe 8. With this configuration, it is possible to supply a sufficient amount of oil to a second oil passage located downstream of the first oil passage 43 while appropriately supplying the oil to the first oil passage 43.

Although not illustrated, the downstream-side straight pipe portion 82 of the oil pipe 8 extends (may be bent) upward in FIG. 2, and an end portion of the downstream-side straight pipe portion 82 is inserted into an opening provided in the wall 40 of the cover member 4. The opening communicates with the second oil passage provided in the wall 40, so that the oil is supplied to, for example, the bearing of the shaft of the secondary pulley.

As described above, in the continuously variable transmission according to the present embodiment, it is possible to supply the oil from the oil pipe 8 attached to the cover member 4 of the transmission case 1 to each of the first oil passage 43 and the second oil passage that are provided in the cover member 4. That is, an oil pump (not illustrated) is operated while the automobile is traveling, so that the oil is drawn up from the oil pan 5 and is then supplied to, for example, the bearings that support the end portions of the shafts of the continuously variable transmission mechanism, the differential, and so forth.

In this case, the oil is supplied from the first oil passage 43 provided in the boss 41 to the ball bearing 7 that is disposed in the boss 41 of the cover member 4 to support the end portion 6a of the pulley shaft 6. That is, as schematically indicated by the arrows in FIG. 2, a portion of the oil flows out of the through-hole 82a of the oil pipe 8, and then flows from the opening 41c of the outer peripheral surface 41b of the boss 41 into the first oil passage 43. Then, the oil is supplied from the end portion 6a of the pulley shaft 6 to the ball bearing 7, in the oil chamber 44 in the boss 41.

The oil other than the oil flowing out of the through-hole 82a flows downstream through the oil pipe 8, flows into the second oil passage in the cover member 4 from the end portion of the oil pipe 8, and is then supplied to, for example, the bearing of the shaft of the secondary pulley through the second oil passage. In this way, it is possible to supply the oil to a plurality of oil passages without the need to braze the branch pipe to the oil pipe 8. As a result, it is possible to curb cost increases.

FIG. 3 illustrates an example of a structure in related art, for supplying oil from one oil pipe to a plurality of portions as in the present embodiment. As illustrated in FIG. 3, an end portion of an oil pipe 85 is inserted into an opening of a first oil passage 45 provided in a wall 40 of a cover member 4 and a branch pipe 86 is connected to an intermediate portion of the oil pipe 85 to allow the flow of the oil to branch off.

FIG. 3 illustrates an example of the structure provided on the assumption that an end portion of the branch pipe 86 is brazed to the oil pipe 85. In this case, a through-hole 85a is provided in the oil pipe 85 and the end portion of the branch pipe 86 is brazed to the oil pipe. As a result, the component cost is increased, and the number of man-hours needed is also increased. This results in a cost increase.

In contrast to this, in the present embodiment, the oil is supplied from the through-hole 82a of the oil pipe 8 into the first oil passage 43 in the boss 41 of the cover member 4. Further, the end portion of the oil pipe 8 is inserted into the second oil passage, whereby the oil can be supplied to the second oil passage. Therefore, the branch pipe 86 is not required, and brazing of the branch pipe 86 is not required. As a result, it is possible to curb cost increases.

### Other Embodiments

The configuration of the present disclosure is not limited to the foregoing embodiment, and the present disclosure may include various other embodiments. For example, in the foregoing embodiment, the first oil passage 43 is provided in the boss 41 of the cover member 4 of the transmission case 1, and the through-hole 82a of the oil pipe 8 is provided adjacent to the opening 41c of the outer peripheral surface 41b. However, the present disclosure is not limited to this configuration.

For example, an oil passage may be provided in the boss 42 of the cover member 4, an oil passage may be provided in a portion of the wall 40 of the cover member 4 other than the bosses 41, 42, or an oil passage may be provided in the case member (e.g. the center case 2, or the side case 3) other than the cover member 4.

In the foregoing embodiment, the oil pipe 8 has an L-shape, and the through-hole 82a is provided in the downstream-side straight pipe portion 82, at a position in the vicinity of the bent pipe portion 83. Alternatively, the through-hole 82a may be provided in the bent pipe portion 83, or may be provided at a portion apart from the bent pipe portion 83. The shape of the oil pipe 8 is not limited to an L-shape, and the oil pipe 8 need not be disposed in the cover member 4 or the like.

With the structure according to the present disclosure, the oil is supplied from one oil pipe to a plurality of oil passages provided in the case member of the transmission apparatus, and cost increases can be curbed. Therefore, the present disclosure produces remarkable effects when being applied to, for example, a transmission of an automobile.

What is claimed is:

1. A lubrication structure of a power transmission apparatus including a case member, the lubrication structure comprising:
a first oil passage provided in the case member of the power transmission apparatus, the first oil passage including a first opening that opens at a wall surface of the case member;
a second oil passage provided in the case member of the power transmission apparatus, the second oil passage including a second opening that opens at the wall surface of the case member; and
an oil passage pipe attached to the wall surface of the case member, the oil passage pipe including an end portion inserted into the second opening to be connected to the second oil passage, the oil passage pipe including a through-hole that opens at an outer peripheral surface of the oil passage pipe, and the through-hole being provided adjacent to the first opening such that oil is supplied from the through-hole into the first oil passage.

2. The lubrication structure according to claim 1, wherein a cross-sectional area of the through-hole is smaller than a cross-sectional area of the first opening of the first oil passage.
